(19) United States
(12) Patent Application Publication
(10) Pub. No.: US 2008/0106067 A1
(43) Pub. Date: May 8, 2008

(54) Trailer Coupler Apparatus and Methods

(75) Inventor: Douglas W. Kissack, Rozet, WY (US)

Correspondence Address: SANTANGELO LAW OFFICES, P.C., 125 SOUTH HOWES, THIRD FLOOR, FORT COLLINS, CO, 80521, US

(73) Assignee: TRANSPORTATION TECHNOLOGIES, LLC, Rozet, WY (US)

(21) Appl. No.: 11/555,924

(22) Filed: Nov. 2, 2006

(51) Int. Cl. B60D 1/06

(52) U.S. Cl. 280/511

(57) ABSTRACT

At least one embodiment of the inventive technology may be a ball hitch coupler apparatus that include a housing, an upward ball movement obstructor; a rotatable rod, and a rod biaser established so as to bias the rotatable rod towards a terminal, rod rotation position. The rotatable rod may define a spatial recess that, upon appropriate positioning, may allow for passage of a ball of a ball hitch so that, upon subsequent reconfiguration of the rotatable rod, the ball may be captured, resulting in a coupling needed for, e.g., towing.

### I. BACKGROUND OF THE INVENTION

Generally, this inventive technology relates to apparatus and related methods for coupling two items. More specifically, embodiments of the inventive technology focus on apparatus and methods useful for coupling ball hitches, and as a result, the tow vehicle to which a ball hitch is attached, to whatever is towed, whether trailer or otherwise.

### II. SUMMARY OF THE INVENTION

At least one embodiment of the inventive technology may be a ball hitch coupler apparatus that include a housing, an upward ball movement obstructor; a rotatable rod, and a rod biaser established so as to bias the rotatable rod towards a terminal, rod rotation position. The rotatable rod, which preferably may be rotatable about a longitudinal rod axis, may contact (whether directly or not) the ball when the apparatus is in a ball capture configuration. The rotatable rod may define a spatial recess that, upon appropriate positioning, may allow for passage of a ball of a ball hitch so that, upon subsequent reconfiguration of the rotatable rod, the ball may be captured, resulting in a coupling needed for, e.g., towing.

A goal of particular embodiments of the inventive technology is to provide a ball hitch coupler that is easy to operate and strong.

Another goal of particular embodiments of the inventive technology is to provide a quick-coupling system for hooking up a horse/livestock, cargo, racecar hauler, flat bed gooseneck style trailer to a tow vehicle.

Naturally, further objects of the invention are disclosed throughout other areas of the specification and claims.

### III. BRIEF DESCRIPTION OF THE DRAWINGS

It is of note that the dimensions indicated with numbers on the figures are exemplary only and do not in any fashion limit the scope of the inventive technology.

FIG. 1 shows a view of an embodiment of the coupler apparatus.

FIGS. 2A and 2B show a view of part of an embodiment of the coupler apparatus, in addition to a ball hitch (only partially shown in FIG. 2B).

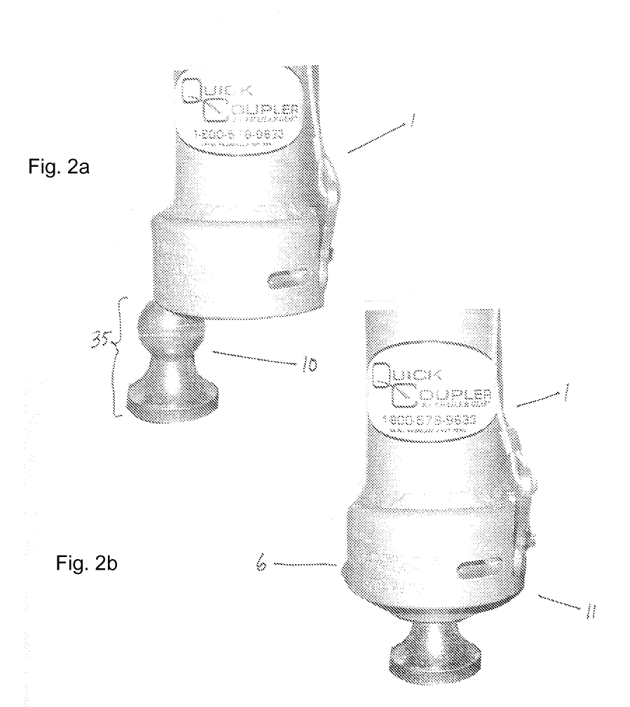

FIG. 3 shows a view of part of an embodiment of the coupler apparatus in ball capture configuration.

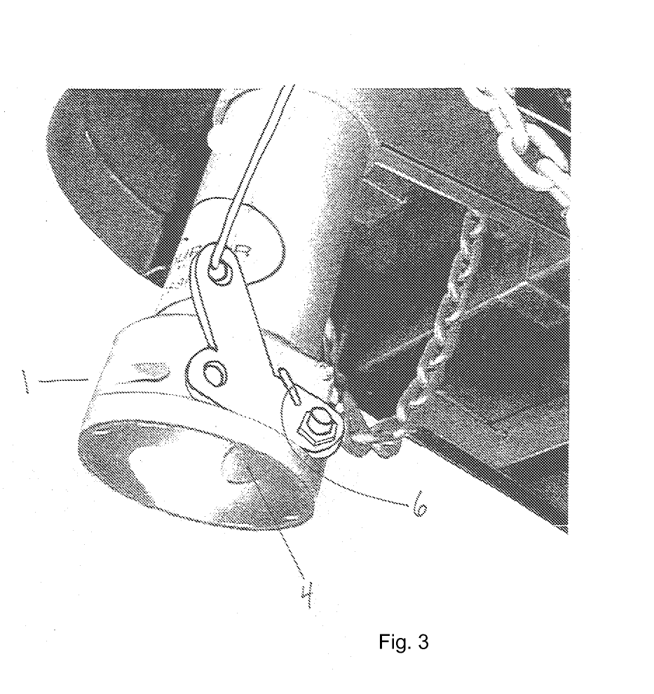

FIG. 4 shows a view of part of an embodiment of the coupler apparatus in ball release configuration.

FIGS. 5A and 5B show views of an embodiment of the coupler apparatus (an adjustable fifth wheel to ball type conversion) in ball capture configuration (FIG. 5A) and ball release configuration (FIG. 5B).

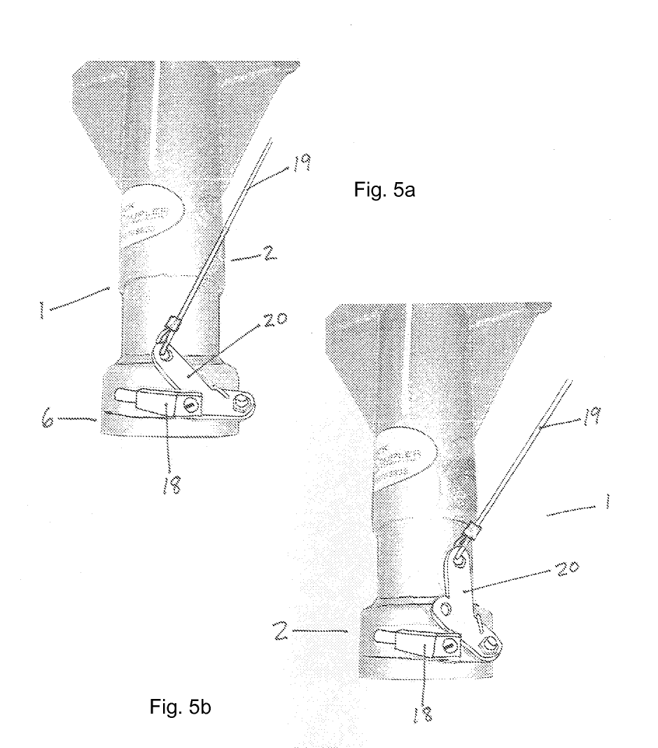

FIGS. 6A and 56B show views (from below) of an embodiment of the coupler apparatus in ball capture configuration (FIG. 6A) and ball release configuration (FIG. 6B).

FIGS. 7A and 7B show cross-sectional and side views, respectively, of the housing of embodiment(s) of the inventive coupler apparatus.

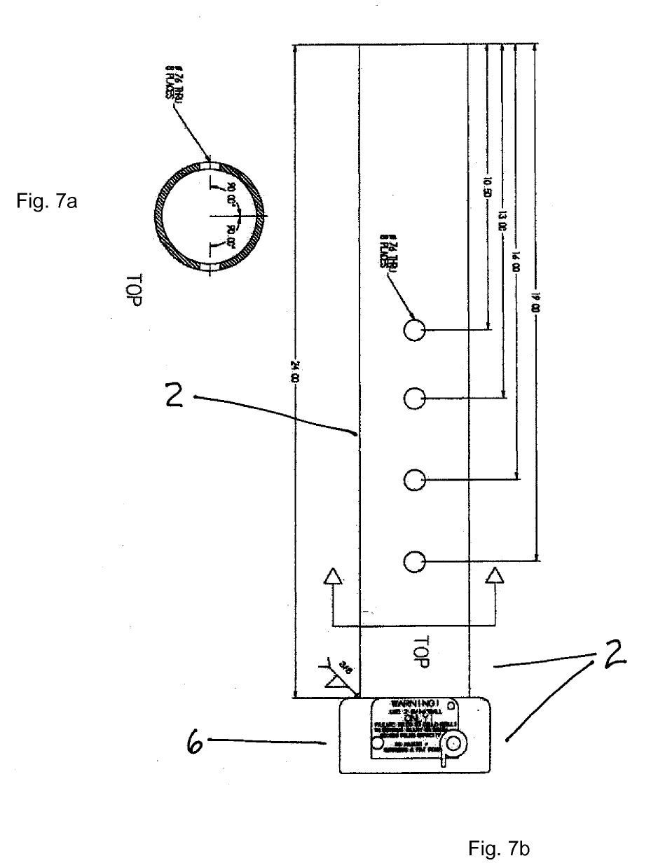

FIGS. 8A and 8B show cross-sectional views of a bottom part of the apparatus housing, including the upward ball movement obstructor and the dual funnel opening as may appear in embodiment(s) of the inventive coupler apparatus.

FIGS. 9A and 9B show side views of a bottom part of the apparatus housing in embodiment(s) of the inventive technology.

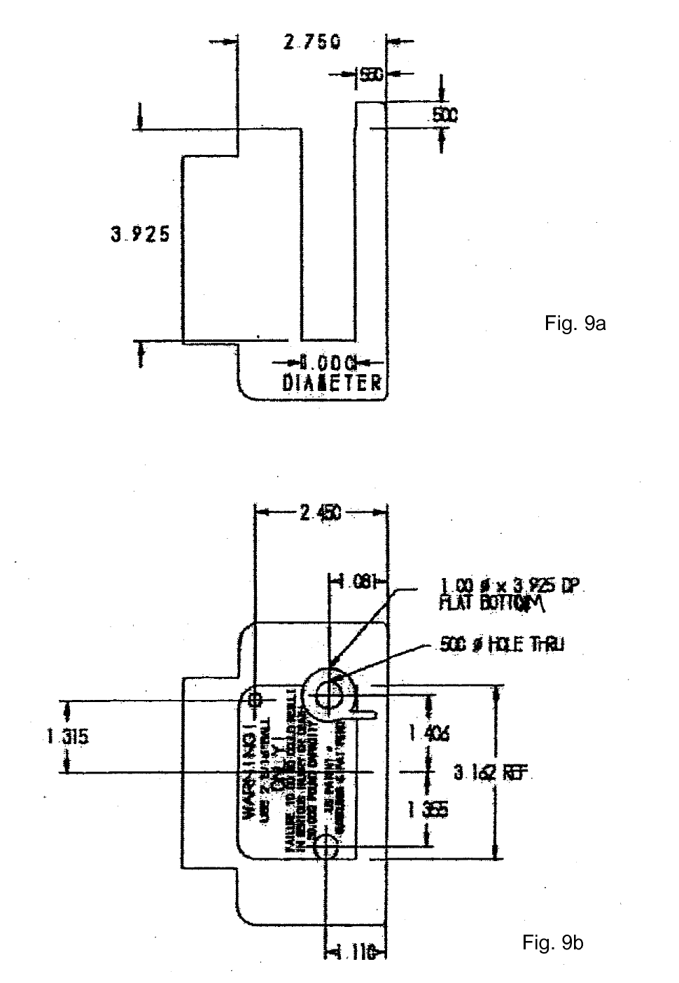

FIG. 10A and 10B show side views of a bottom part of the apparatus housing in embodiment(s) of the inventive technology.

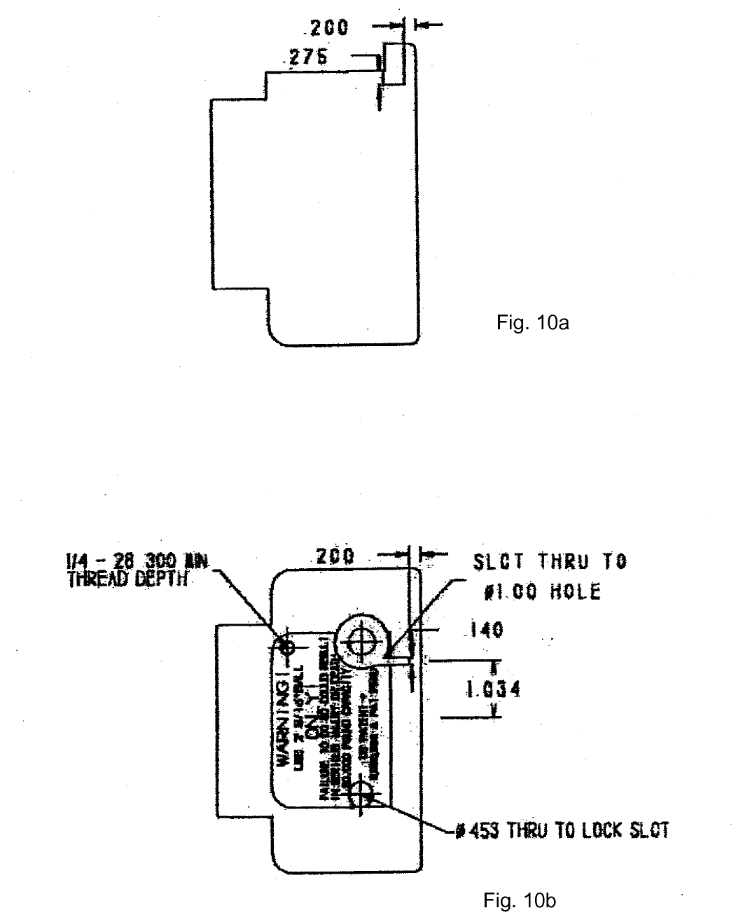

FIG. 11A and 11B show side views of a bottom part of the apparatus housing in embodiment(s) of the inventive technology.

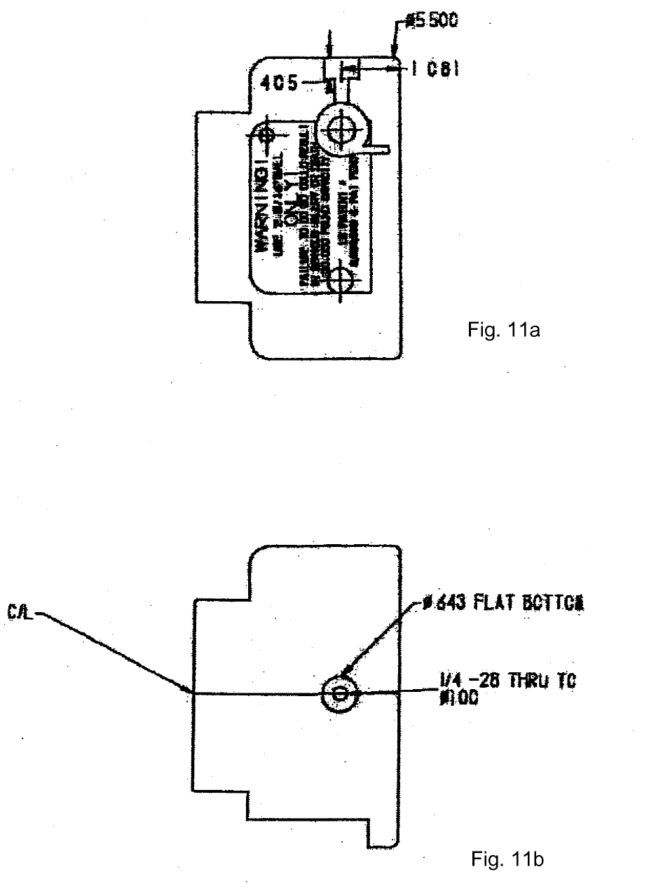

FIGS. 12A and 12B show side views of a bottom part of the apparatus housing in embodiment(s) of the inventive technology.

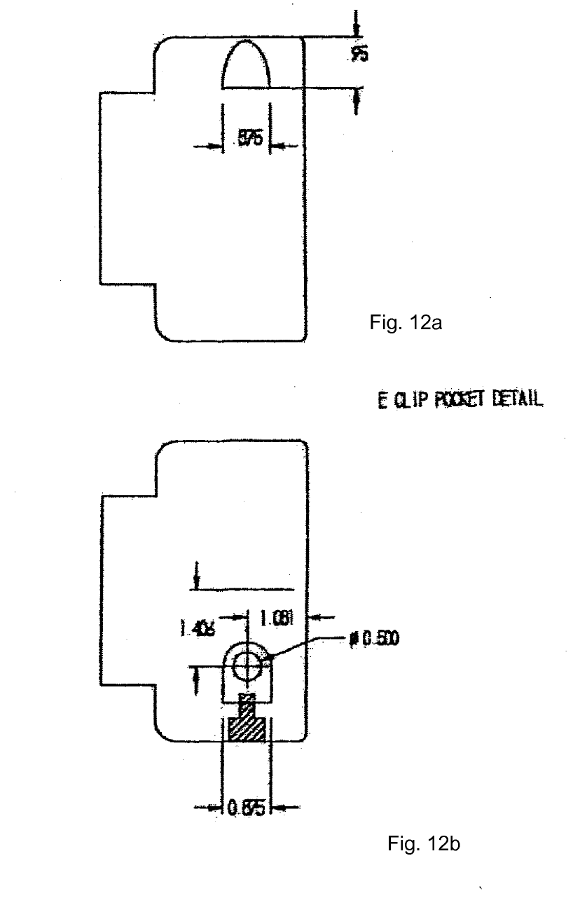

FIG. 13A, 13B and 13C show side views of a bottom part of the apparatus housing in embodiment(s) of the inventive technology. FIG. 13D shows possible relative disposition of possible features of the housing as may appear in embodiment(s) of the inventive technology.

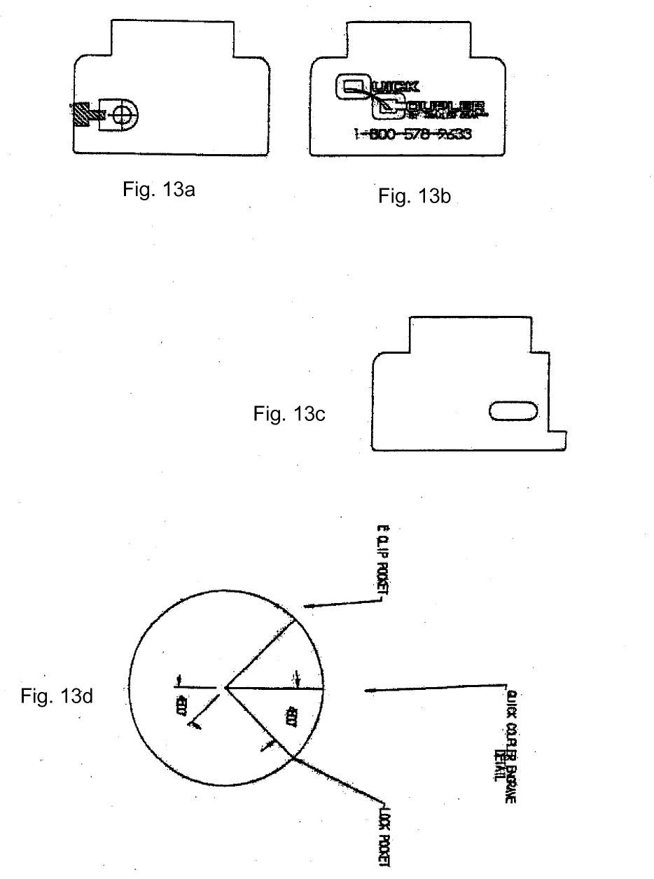

FIG. 14A shows merely the outer profile (inner spaces, contours, etc. not shown) of a bottom part of the housing in an embodiment of the inventive technology, while FIG. 14B shows a side view of a bottom part of the apparatus housing in embodiment(s) of the inventive technology.

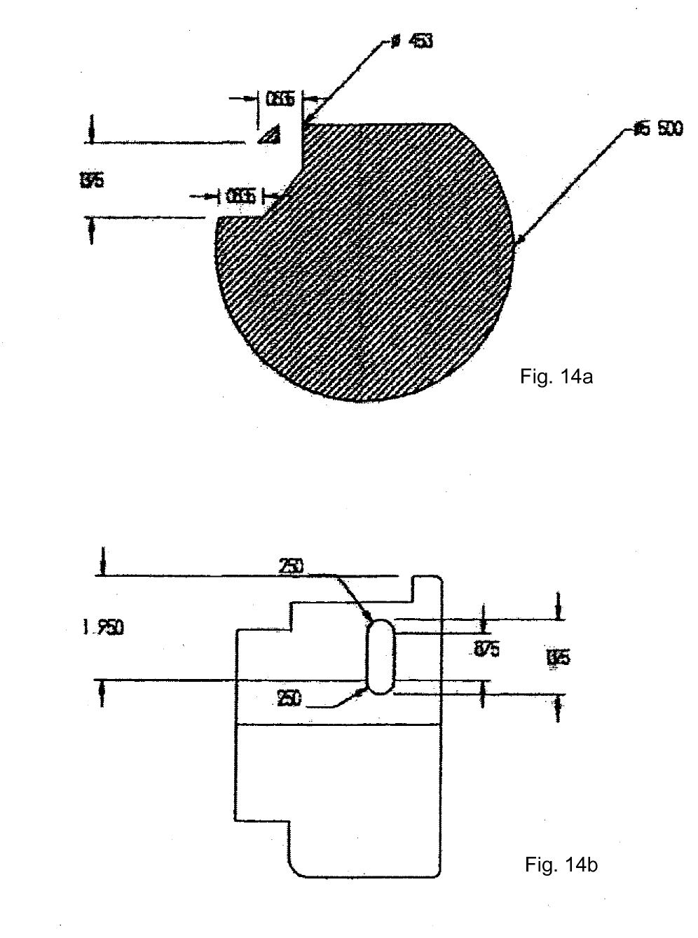

FIG. 15A, 15B and 15C show cross-section, and two side views (at different rod rotation positions) of a rotatable rod, while FIG. 15D shows a side view of a torsion spring, as may appear in embodiment(s) of the inventive technology.

FIGS. 16A and 16B show side views of a rotatable rod as may appear in embodiment(s) of the inventive technology.

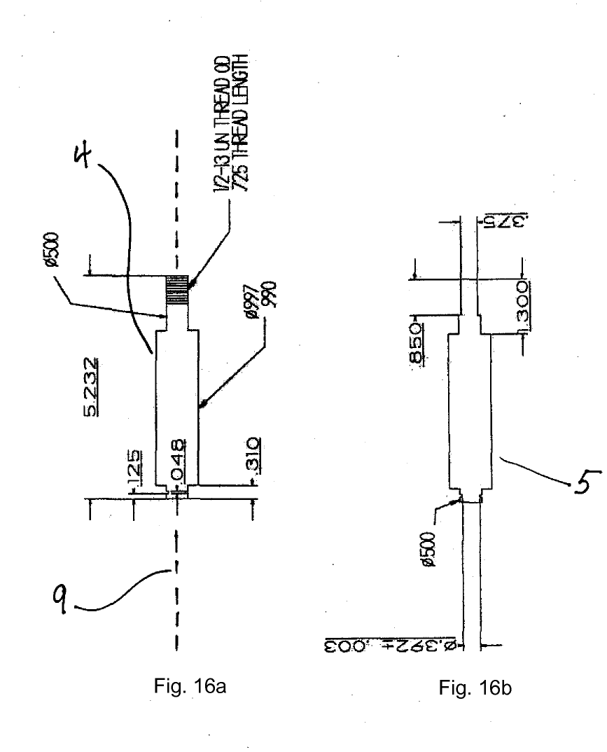

FIGS. 17A and 17B show a latch arm, in view from above (FIG. 17A) and side view (FIG. 17B) as may appear in embodiment(s) of the inventive technology.

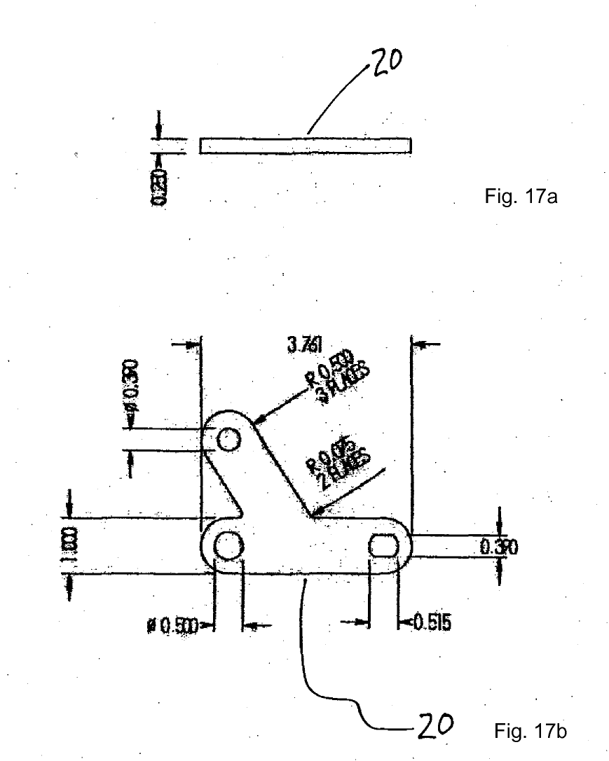

FIGS. 18A and 18B show tow vehicles and trailers coupled by the inventive apparatus.

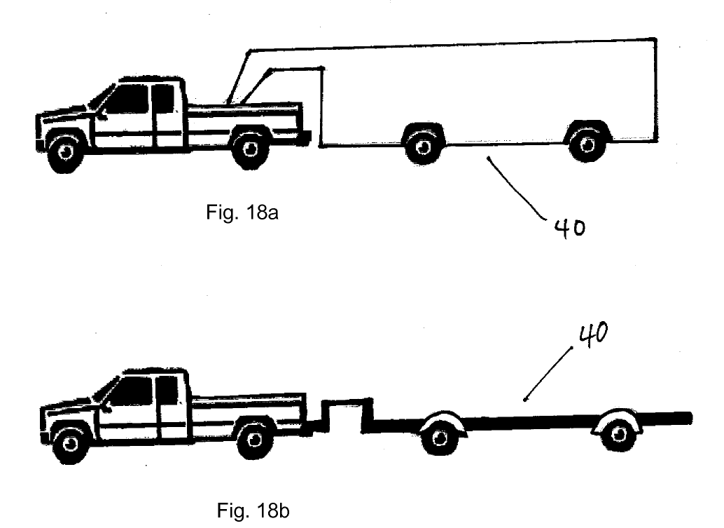

### IV. DETAILED DESCRIPTION OF THE PREFERRED EMBODIMENTS

As mentioned earlier, the present invention includes a variety of aspects, which may be combined in different ways. The following descriptions are provided to list elements and describe some of the embodiments of the present invention. These elements are listed with initial embodiments, however it should be understood that they may be combined in any manner and in any number to create additional embodiments. The variously described examples and preferred embodiments should not be construed to limit the present invention to only the explicitly described systems, techniques, and applications. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

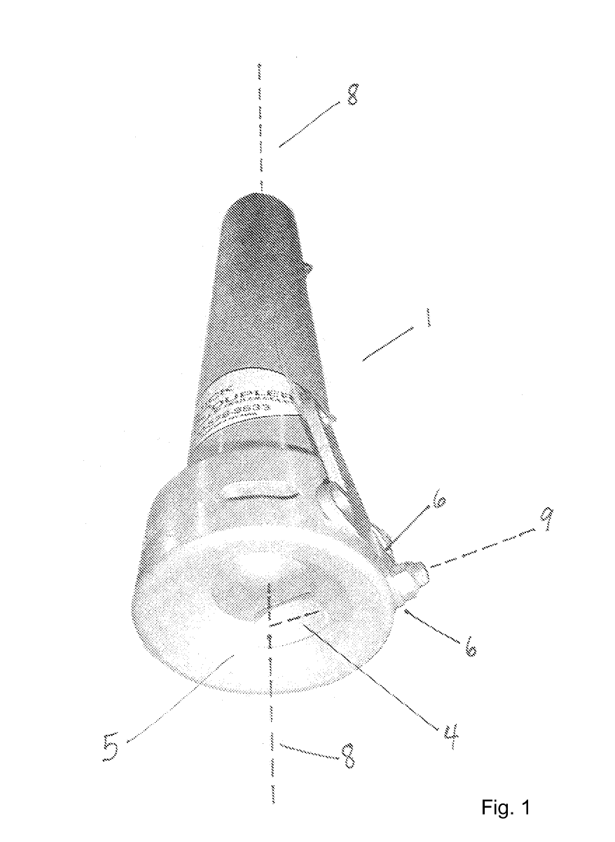

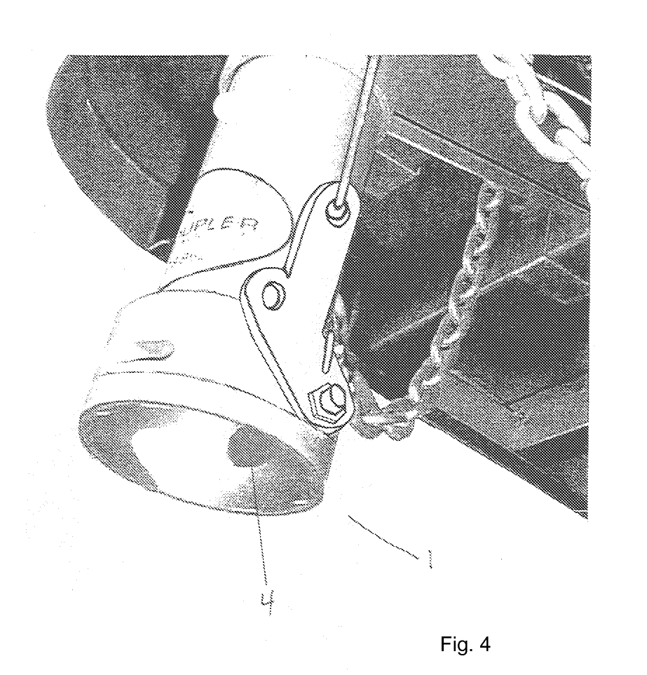

At least one embodiment of the inventive technology may be a ball hitch coupler apparatus 1 that comprises a housing 2, an upward ball movement obstructor 3 established in the housing; a rotatable rod 4 established at least partially in central shaft space 5 defined by the housing and substantially at a bottom housing end 6; and a rod biaser 7 established so as to bias the rotatable rod towards a terminal, rod rotation position (see, e.g., FIGS. 1A, 4 and 6A). The housing may also define a longitudinal housing axis 8. The rotatable rod, which preferably may be rotatable about a longitudinal rod axis 9, may contact (whether directly or not) the ball 10 of ball hitch 35 when the apparatus is in a ball capture configuration 11; the longitudinal rod axis, in preferred embodiments, is substantially non-vertical when the apparatus is in the ball capture configuration. It is of note that the term “substantially at a bottom housing end” is a broad term that includes not only precisely at the bottom end, but also in the vicinity thereof, including, but not limited to within 6 inches thereof.

It is of note that in at least one embodiment of the inventive technology, the rotatable rod defines a spatial recess 30 which may be a spatial scallop 13 (e.g., a space that appears “scooped out” or sliced off of the rod). Of course, such a spatial scallop is only one example of the many types of spatial recesses that may suffice. It is also of note that in preferred embodiments, the spatial recess (whether a spatial scallop or not) and the rotatable rod are coordinated such that when the apparatus is in a ball release configuration 12, the rotatable rod does not obstruct vertical movement of the ball relative to the housing, and when the apparatus is in a ball capture configuration 11, the rotatable rod obstructs lowering of the ball relative to the housing. Such coordination—which may involve positioning, during apparatus manufacture or use, of each the spatial recess and the rod relative to one another, and relative to the housing—may enable the rod to effect capture and, alternatively, release, of the ball 10 of the ball hitch 35 in the housing, as desired.

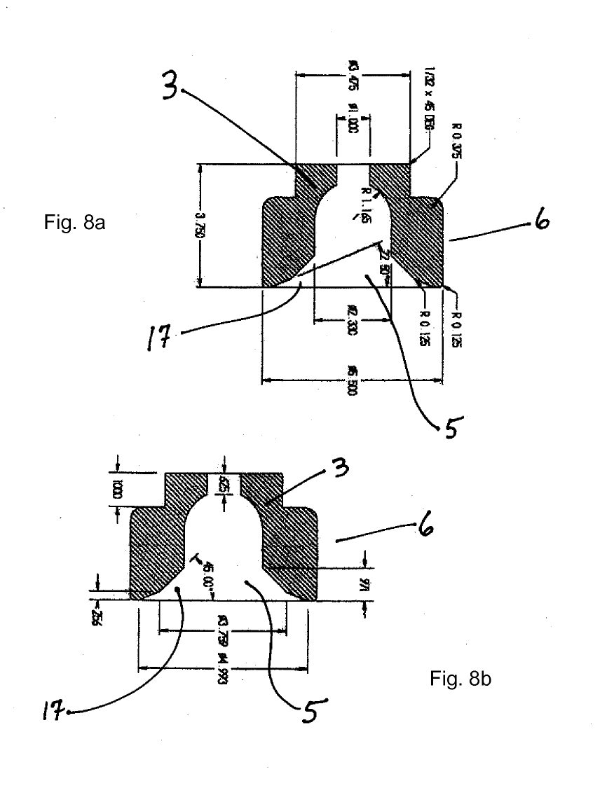

As is clear from the drawings, in at least one embodiment, the spatial recess (e.g., a spatial scallop) may allow vertical movement of the rod relative to the housing (ball release configuration), while the rod, upon rotation (perhaps of approximately 45 degrees) may obstruct downward movement of the ball relative to the housing. In preferred embodiments, an upward ball movement obstructor 3 obstructs upward movement of the ball only, and does so merely by physical interference with upward ball travel (see FIG. 8). Of course, ball capture needed during transportation of a trailer (or whatever is coupled to the tow vehicle), while ball release is needed when uncoupling of the ball hitch is desired.

In certain embodiments, the rod biaser may be a spring (e.g., a torsion spring 14) that acts to bias the rod in either a ball capture rod position 15 (preferred) or a ball release rod position 16. The rod itself may be, as but one example, circular in cross-section (at least in part). It should be noted that in preferred embodiments, the longitudinal axis of the rod is substantially horizontal when the apparatus is in either ball capture or ball release configuration and that, during rotation of the rotatable rod, it does not translate. It is also of note that, in particular embodiments, when the apparatus is in a ball capture configuration, the rotatable rod directly contacts the ball. Further, as in certain embodiments the rod biaser biases the rod in a ball capture rod position, the rod may be in such position not only when the apparatus is acting to couple a trailer to a ball, but also when the trailer and the ball are entirely uncoupled. In such embodiments, the rod is in ball release rod position only when the rod is affirmatively moved (e.g., by an operator of the apparatus) from its default, ball capture rod position (to which it is biased in certain embodiments); such affirmative movement is typically effected during a coupling or uncoupling operation.

Other apparatus features relate to a dual funnel opening 17 defined by the bottom housing end. Such feature may assist in establishing, during operation of the apparatus, the ball of the ball hitch in the apparatus' housing. There may be provided a padlock device 18 usable to lock the apparatus in its ball capture configuration. Further, the apparatus may be remotely reconfigurable from its ball capture configuration to a ball release configuration via, as but one example, a cable 19 and a latch arm 20 to which the cable is attached. Of course, pulling the cable would, in at least one embodiment, rotate the rotatable rod such that the spatial recess would be positioned to allow passage of the ball relative to the housing. Such is the case, at least, where the rotatable rod is biased in a ball capture rod position. Such is believed to be a safer design, as the default position is ball capture, but certainly the alternate design is possible.

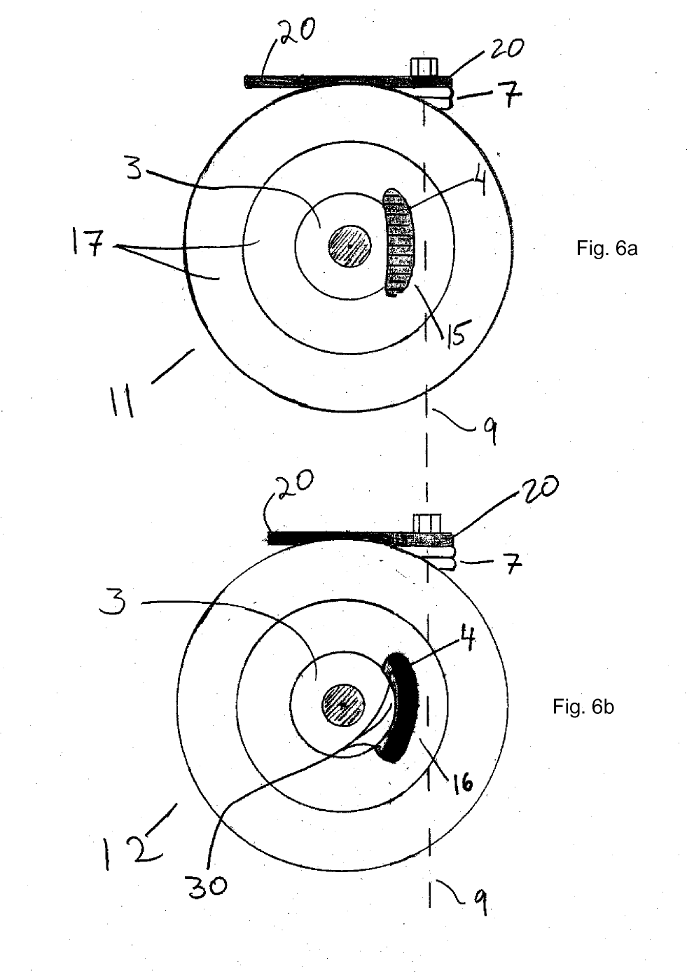

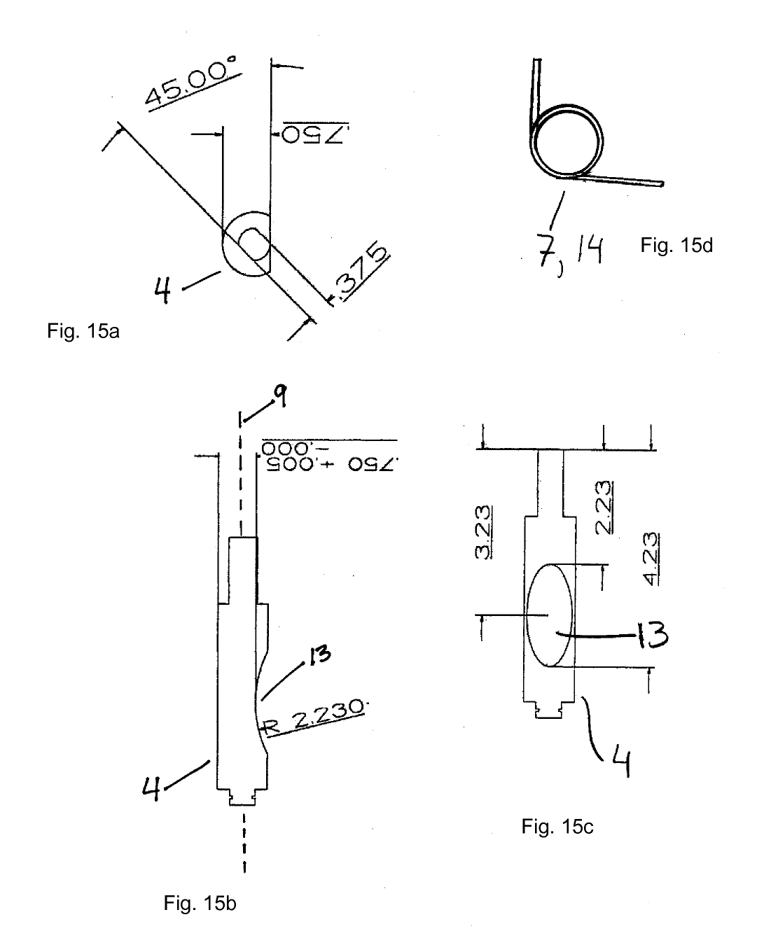

At least one embodiment may be a ball hitch coupler apparatus that has a housing that defines a central shaft space large enough to accept a ball of a ball hitch, an upward ball movement obstructor established in the housing, a rotatable rod established at least partially in the housing's central shaft space and substantially at the bottom end of the housing, and a rod biaser established so as to bias the rotatable rod towards a ball capture rod position. As in other embodiments (and as shown in FIGS. 6A, 6B and 15B), the rotatable rod may define a spatial recess and a longitudinal rod axis that may be coordinated such that when the apparatus is in an ball release configuration, the rotatable rod does not obstruct vertical movement of the ball relative to the housing, and when the apparatus is in a ball capture configuration, the rotatable rod obstructs lowering of the ball relative to the housing.

Particular embodiments of the inventive technology can be adjusted down to a 3.5 inch minimum height with a full 5.5 inch ball capture area. Particular embodiments may have a GVWR of 30,000#, a gross tongue weight of 7,500# and may be used only with a 2 5/16 inch ball. Of course, these are only examples and do not in any manner limit the scope of the inventive technology; other ball sizes may be used if componentry is sized appropriately and, indeed, componentry may sized to a different capacity. It is of note also that the inventive apparatus may be used to couple a trailer 40 (or other towed item) to a ball hitch regardless of whether that ball hitch is the only tow side hitch or part of a converter (e.g., a fifth wheel converter). Although certain apparatus designs focus on gooseneck trailers that are not of the 5^{th} wheel type, other designs may be adapted to fit onto fifth wheels, and, of course, onto a ball type converter that may be on the towing vehicle.

Of course, as would be readily understood by anyone of ordinary skill in the art, it may be necessary to remove any trailer side ball hitch coupler that may come with the trailer, or that may have been attached, in order to expose the column (in the case on non-fifth wheel trailers) so that the apparatus may be attached thereto.

As can be easily understood from the foregoing, the basic concepts of the present invention may be embodied in a variety of ways. It involves both coupling techniques as well as devices to accomplish the appropriate coupling. In this application, the coupling techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this patent application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention is described in device-oriented terminology, each element of the device implicitly performs a function. Apparatus claims may not only be included for the device described, but also method or process claims may be included to address the functions the invention and each element performs. Neither the description nor the terminology is intended to limit the scope of the claims that will be included in any subsequent patent application.

It should also be understood that a variety of changes may be made without departing from the essence of the invention. Such changes are also implicitly included in the description. They still fall within the scope of this invention. A broad disclosure encompassing both the explicit embodiment(s) shown, the great variety of implicit alternative embodiments, and the broad methods or processes and the like are encompassed by this disclosure and may be relied upon when drafting the claims for any subsequent patent application. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of the invention both independently and as an overall system.

Further, each of the various elements of the invention and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “coupler” should be understood to encompass disclosure of the act of “coupling”—whether explicitly discussed or not—and, conversely, were there effectively disclosure of the act of “coupling”, such a disclosure should be understood to encompass disclosure of a “coupler” and even a “means for coupling” Such changes and alternative terms are to be understood to be explicitly included in the description.

Any acts of law, statutes, regulations, or rules mentioned in this application for patent; or patents, publications, or other references mentioned in this application for patent are hereby incorporated by reference. Any priority case(s) claimed by this application is hereby appended and hereby incorporated by reference. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in the list of References To Be Incorporated By Reference In Accordance With The Provisional Patent Application or other information statement filed with the application are hereby appended and hereby incorporated by reference, however, as to each of the above, to the extent that such information or statements incorporated by reference might be considered inconsistent with the patenting of this/these invention(s) such statements are expressly not to be considered as made by the applicant(s).

Thus, the applicant(s) should be understood to have support to claim and make a statement of invention to at least: i) each of the coupler devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) each system, method, and element shown or described as now applied to any specific field or devices mentioned, x) methods and apparatuses substantially as described hereinbefore and with reference to any of the accompanying examples, xi) the various combinations and permutations of each of the elements disclosed, xii) each potentially dependent claim or concept as a dependency on each and every one of the independent claims or concepts presented, and xiii) all inventions described herein.

With regard to claims whether now or later presented for examination, it should be understood that for practical reasons and so as to avoid great expansion of the examination burden, the applicant may at any time present only initial claims or perhaps only initial claims with only initial dependencies. Support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible.

Finally, any claims set forth at any time are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

1. A ball hitch coupler apparatus comprising:
a housing that defines:
a central shaft space large enough to accept a ball of a ball hitch; and
a longitudinal housing axis; and
that has a bottom housing end;
said apparatus further comprising:
an upward ball movement obstructor established in said housing;
a rotatable rod established at least partially in said central shaft space substantially at said bottom housing end; and
a rod biaser established so as to bias said rotatable rod towards a terminal, rod rotation position,
wherein said rotatable rod contacts said ball when said apparatus is in a ball capture configuration,
wherein said rotatable rod defines a longitudinal rod axis,
wherein said rotatable rod is rotatable about said longitudinal rod axis, and
wherein said longitudinal rod axis is substantially non-vertical when said apparatus is in said ball capture configuration.

2. A ball hitch coupler apparatus as described in claim 1 wherein at least part of said rod is circular in cross-section.

3. A ball hitch coupler apparatus as described in claim 1 wherein said rotatable rod defines a spatial recess.

4. A ball hitch coupler apparatus as described in claim 3 wherein said spatial recess is a spatial scallop.

5. A ball hitch coupler apparatus as described in claim 3 wherein said spatial recess and said rotatable rod are coordinated such that when said apparatus is in a ball release configuration, said rotatable rod does not obstruct vertical movement of said ball relative to said housing, and when said apparatus is in said ball capture configuration, said rotatable rod obstructs lowering of said ball relative to said housing.

6. A ball hitch coupler apparatus as described in claim 1 wherein, during rotation of said rotatable rod, said rotatable rod does not translate.

7. A ball hitch coupler apparatus as described in claim 1 wherein said rod biaser comprises a spring

8. A ball hitch coupler apparatus as described in claim 7 wherein said spring comprises a torsion spring

9. A ball hitch coupler apparatus as described in claim 1 wherein said terminal, rod rotation position is a ball capture rod position.

10. A ball hitch coupler apparatus as described in claim 1 wherein said longitudinal rod axis is substantially horizontal when said apparatus is in said ball capture configuration.

11. A ball hitch coupler apparatus as described in claim 1 wherein said rotatable rod directly contacts said ball when said apparatus is in said ball capture configuration.

12. A ball hitch coupler apparatus as described in claim 1 wherein said bottom housing end defines a dual funnel opening.

13. A ball hitch coupler apparatus as described in claim 1 further comprising a padlock device usable to lock said apparatus in said ball capture configuration.

14. A ball hitch coupler apparatus as described in claim 1 wherein said apparatus is remotely reconfigurable from said ball capture configuration to a ball release configuration.

15. A ball hitch coupler apparatus as described in claim 14 further comprising a cable and a latch arm to which said cable is attached.

16. A ball hitch coupler apparatus as described in claim 1 further comprising a latch arm attached to said rotatable rod.

17. A ball hitch coupler apparatus as described in claim 17 further comprising said ball hitch.

18-33. (canceled)

34. A ball hitch coupler apparatus comprising:
a housing that defines:
a central shaft space large enough to accept a ball of a ball hitch; and
a longitudinal housing axis; and
that has a bottom housing end;
said apparatus further comprising:
an upward ball movement obstructor established in said housing;
a rotatable rod established at least partially in said central shaft space substantially at said bottom housing end; and
a rod biaser established so as to bias said rotatable rod towards a ball capture rod position,
wherein said rotatable rod defines a spatial recess and a longitudinal rod axis, and
wherein said spatial recess and said rotatable rod are coordinated such that when said apparatus is in a ball release configuration, said rotatable rod does not obstruct vertical movement of said ball relative to said housing, and when said apparatus is in a ball capture configuration, said rotatable rod obstructs lowering of said ball relative to said housing.

35. A ball hitch coupler apparatus as described in claim 34 wherein said rotatable rod is rotatable about said longitudinal rod axis.

36. A ball hitch coupler apparatus as described in claim 34 wherein said rotatable rod contacts said ball when said apparatus is in said ball capture configuration.

37. A ball hitch coupler apparatus as described in claim 36 wherein said rotatable rod directly contacts said ball when said apparatus is in said ball capture configuration.

38. A ball hitch coupler apparatus as described in claim 34 wherein said longitudinal rod axis is substantially non-vertical when said apparatus in is said ball capture configuration.

39. A ball hitch coupler apparatus as described in claim 38 wherein said longitudinal rod axis is substantially horizontal when said apparatus is in said ball capture configuration.

40. A ball hitch coupler apparatus as described in claim 34 wherein said spatial recess comprises a spatial scallop.

41. A ball hitch coupler apparatus as described in claim 34 wherein at least part of said rod is circular in cross-section.

42. A ball hitch coupler apparatus as described in claim 34 wherein, during rotation of said rotatable rod, said rotatable rod does not translate.

43. A ball hitch coupler apparatus as described in claim 34 wherein said rod biaser comprises a spring.

44. A ball hitch coupler apparatus as described in claim 43 wherein said spring comprises a torsion spring.

45. A ball hitch coupler apparatus as described in claim 34 wherein said bottom housing end defines a dual funnel opening.

46. A ball hitch coupler apparatus as described in claim 34 further comprising a padlock device usable to lock said apparatus in said ball capture configuration.

47. A ball hitch coupler apparatus as described in claim 34 wherein said apparatus is remotely reconfigurable from said ball capture configuration to said ball release configuration.

48. A ball hitch coupler apparatus as described in claim 47 further comprising a cable and a latch arm to which said cable is attached.

49. A ball hitch coupler apparatus as described in claim 34 further comprising a latch arm attached to said rotatable rod.

50. A ball hitch coupler apparatus as described in claim 34 further comprising said ball hitch.

51-66. (canceled)
